(19) United States
(12) Patent Application Publication
(10) Pub. No.: US 2008/0156584 A1
(43) Pub. Date: Jul. 3, 2008

(54) LADDER STABILIZER

(76) Inventor: Joseph Anthony Simonetti, Bellingham, MA (US)

Correspondence Address: DAVID J. COLE, 7 LAKESHORE DRIVE, MEDWAY, MA, 02053-1034, US

(21) Appl. No.: 11/617,864

(22) Filed: Dec. 29, 2006

(51) Int. Cl. E06C 7/42

(52) U.S. Cl. 182/107

(57) ABSTRACT

A ladder stabilizer comprises a central section and two side sections extending in substantially the direction from opposed ends of the central section. When the stabilizer is placed with the free ends of the side sections in contact with a vertical wall of a building and the side sections and the central section lying substantially in a horizontal plane, the central section provides a substantially planar surface facing away from the vertical wall and lying at an angle of from about 12 to about 23 degrees, and desirably about 17.5 degrees, to the vertical. This enables the side sections to extend horizontally even when the ladder is used at its normal inclination to the vertical.

### BACKGROUND OF THE INVENTION

This invention relates to a ladder stabilizer. More specifically, it relates to a ladder stabilizer which is designed to extend essentially horizontally while connected to a ladder which is leaning at a substantial angle to the vertical. Preferred forms of the ladder stabilizer of the present invention can provide a convenient support for a paint tray and other tools used by painters and similar workers.

Various types of ladder stabilizers intended for attachment to the upper ends of ladders resting against building and other tall structures are known. Such stabilizers typically stabilize the ladder by rendering it less likely to slip along or off the wall adjacent which it is placed if the ladder is not placed in a vertical plane and/or the user leans to one side of the ladder while working. However, such stabilizers can serve various other purposes:

(a) the stabilizer can enable a ladder to rest securely against a curved or angled structure, such as a telegraph pole or the corner or a building, in a position in which the ladder itself cannot rest securely;

(b) the stabilizer can enable a ladder to extend above the edge of the roof of a building without damaging a relatively fragile gutter running along that edge and/or without damaging a roofing material such as asphalt shingles; see, for example, U.S. Pat. No. 7,093,689;

(c) the stabilizer may provide additional storage capacity for articles needed by the user of the ladder; see, for example, U.S. Pat. No. 6,244,383;

(d) the stabilizer can prevent the upper end of the ladder damaging the vertical wall against which it rests by holding the ladder spaced from the wall, providing an enlarged area of contact between the ladder and the walls, or providing a relatively soft material, for example a rubber or polymer, in contact with the wall; see, for example, U.S. Pat. Nos. 5,113,973; 4,117,941; and 6,092,685; and

(e) the stabilizer may enable the ladder to be used adjacent windows, shutters and other objects placed or on building walls by providing widely spaced points of contacts between the stabilizer and the building so that the stabilizer can bridge the windows, shutters etc. where the relatively narrow ladder itself would not be able to do so.

One common form of ladder stabilizer, exemplified by U.S. Pat. Nos. 5,010,979 and 5,113,973, has essentially the form of a flattened “U”, with a central section which is clamped or otherwise secured to the ladder, and two side sections which extend parallel to each other from the opposed ends of the central section. the free ends of the side sections (the ends remote from the central section) typically being provided with deformable “feet” of rubber or polymer which can contact the vertical wall of a building without damaging the wall. The side sections may be formed separately from the central section and welded or otherwise secured thereto, or the side sections can be formed continuous with the central section by bending the end portions of a single piece of tubing at right angles to the central portion thereof,

Ladder stabilizers are normally made detachable from the ladders with which they are used to enable a single stabilizer to be used with multiple ladders and for ease of transportation; it may be inconvenient to have a wide stabilizer protruding from a narrow ladder when the ladder is placed in a rack on a vehicle. When such stabilizers are in use, the side rails of the ladder rest against a surface of the central section facing away from the building. Accordingly, the central section (and typically also the side sections) of the stabilizer are formed of a square or rectangular cross-section tube in order to provide a flat surface against which these rails can rest. The ladder is typically secured to the stabilizer by two (or more) D-clamps, with the curved part of each D-clamp in contact with one rung of the ladder on the side thereof remote from the stabilizer, and the straight legs of the D-clamp extending on either side of the rung and the central section of the stabilizer, so that the closure member of the clamp rests in contact with the surface of the central section facing the building.

This clamping arrangement safely secures the stabilizer to the ladder such that there is no danger of the two moving relative to one another during use. However, in prior art stabilizers of this type, the central and side sections lie essentially in one plane with the surfaces of the central section in contact with the rails and the closure member extending perpendicular to this plane, so that the side sections extend at right angles to the plane of the ladder rails. Consequently, when the ladder is placed in its normal position inclined at an angle of about 17 to 18 degrees to the vertical (i.e., with the foot of the ladder spaced from the building wall by about one-fourth of the length of the ladder), the side sections of the stabilizer extend downwardly at the same angle to the horizontal.

It has now been realized that this substantial slope of the side sections of the stabilizer when in use is disadvantageous, and that a simple modification of the stabilizer enable the side sections of the stabilizer to extend substantially horizontally when the ladder secured thereto is at its conventional inclination to the vertical, and that such a stabilizer can provide a convenient horizontal surface capable of supporting a paint tray and/or other items useful to the user of the ladder/

### SUMMARY OF THE INVENTION

Accordingly, this invention provides a ladder stabilizer comprising a central section and two side sections extending in substantially the direction from opposed ends of the central section, such that when the stabilizer is placed with the free ends of the side sections in contact with a vertical wall of a building and the side sections and the central section lying substantially in a horizontal plane, the central section provides a substantially planar surface facing away from the vertical wall and lying at an angle of from about 12 to about 23 degrees to the vertical.

In the ladder stabilizer of the present invention, the substantially planar surface may conveniently lie at an angle of about 15 to about 20, and preferably about 16 to 19, degrees to the vertical under the aforementioned conditions. The optimum angle for the substantially planar surface is about 17.5 degrees to the vertical. Desirably, the central section provides a second substantially planar surface extending substantially parallel to the previously-mentioned (first) substantially planar surface but facing towards the vertical wall. The two substantially planar surfaces on opposed sides of the central section facilitate clamping or otherwise securing the stabilizer to the ladder in the conventional manner as described above.

Very desirably, the ladder stabilizer of the present invention comprises at least one support member extending between the two side sections and spaced from the central section. The support member(s) serve, in conjunction with the central section, as a horizontal rack on which a paint roller tray or other tools may be stored by a worker on the ladder.

The present invention extends to a ladder stabilizer of the present invention secured to a ladder with the side rails of the ladder in contact with the (first) substantially planar surface of the stabilizer.

### BRIEF DESCRIPTION OF THE DRAWINGS

FIG. 1 of the accompanying drawings is a schematic partial top plan view of a preferred ladder stabilizer of the present invention, the stabilizer being illustrated in use secured to a ladder and resting against the vertical wall of a building.

FIG. 2 is a schematic partial side elevation of the ladder and stabilizer shown in FIG. 1 looking upwardly from the bottom edge (as illustrated) of that Figure.

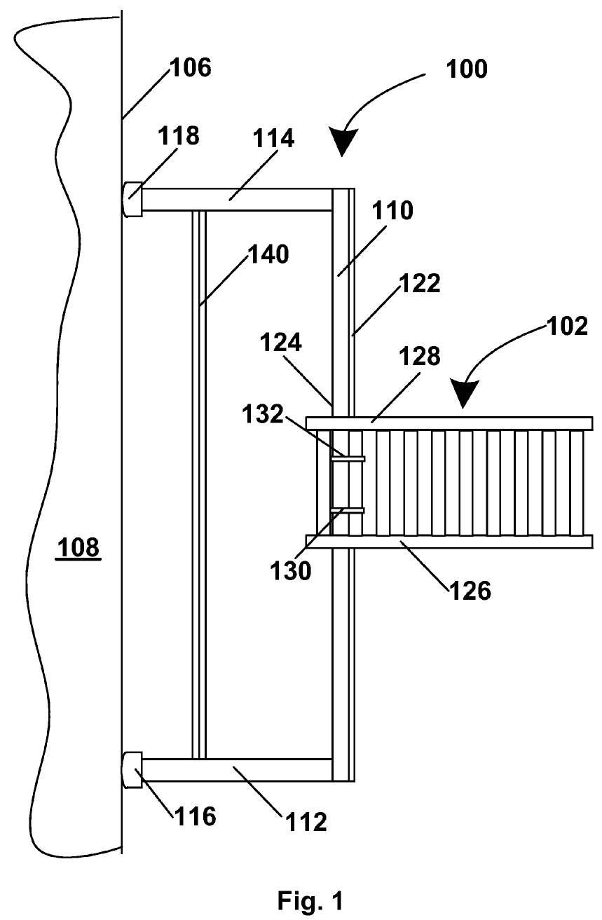

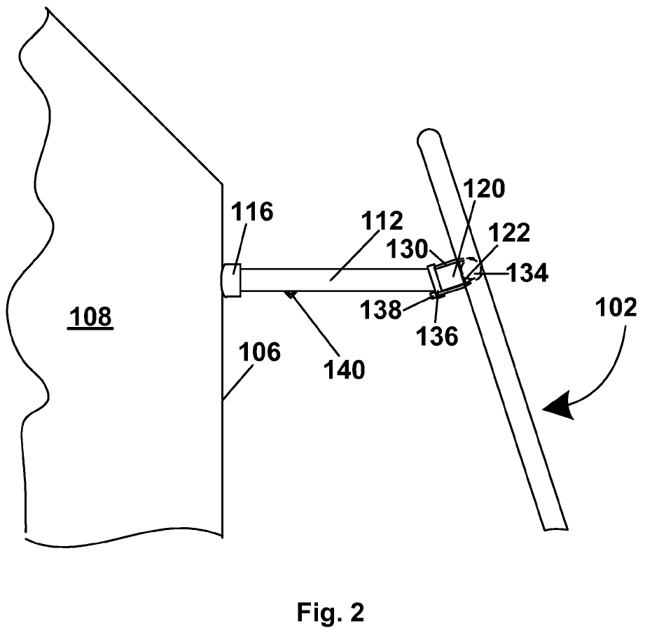

In both FIGS. 1 and 2, the lower part of the ladder is omitted to enable the stabilizer and adjacent part of the ladder to be shown on a larger scale.

### DETAILED DESCRIPTION OF THE INVENTION

FIGS. 1 and 2 illustrate a preferred stabilizer (generally designated 100) of the present invention in use secured to a ladder 102 and resting against a vertical wall 106 of a building 108, only part of which is shown in FIGS. 1 and 2. The stabilizer comprises a central section 110 and two side sections 112, 114, which extend at right angles in the same direction from the opposed ends of the central section 110. The free ends of the side sections 112, 114 bear rubber feet 116, 118 respectively which contact the vertical wall 106, these rubber feet being provided to reduce the risk of damage to the wall.

As best seen in FIG. 2, the ladder 102 lies at an angle of about 17 to 18 degrees to the vertical, this being the angle which experienced workers find most convenient for working from ladders. However, the side sections 112, 114 extend horizontally away from the wall, so that the side sections and the central section 110 lie substantially in a horizontal plane. Both the side sections and the central section are formed from hollow, 1.5 inch (38 mm) square cross-section aluminum alloy tubing having a wall thickness of ⅛ inch (3.2 mm). However, the central section 110 is not simply butt welded on to the ends of the side sections 112, 114 as in some prior art ladder stabilizers. Instead, the ends of the side sections 112, 114 lying adjacent the central section 110 cut at an angle of 17.5 degrees to the vertical and the ends of the central section 110 are welded on to the resultant sloping end surfaces of the end sections 112, 114. The ends of the central section 110 are closed with end caps 120, which may be formed of a polymeric material and which serve to prevent ingress of water, dirt etc into the interior of the central section 110. The notches are shaped so that the square cross-section central section may be regarded as rotated 17.5 degrees from the position it would occupy if butt welded to the side sections 112, 114, so that the outward facing planar surface 122 of the central section lies at an angle of 17.5 degrees to the vertical. The central section also provides a planar surface 124 lying parallel to the surface 122 but facing the wall 106. The side rails 126, 128 of the ladder 102 rest flat against the planar surface 122. Two D-clamps 130, 132 pass around one rung 134 of the ladder 102, and the straight legs of the clamps extend on either side of the central section 110. Closure members 136 of the D-clamps 130, 132 are held by nuts 138 flat against the planar surface 124 of the central section 110, thus securing the ladder 102 to the stabilizer 100.

A support member 140 extends between the side sections 112, 114 at a position spaced from the central section 110. As best seen in FIG. 2, the support member is of substantially V-shaped cross-section, and is intended to accommodate the flat base of the “deep end” of a conventional paint roller tray (not shown); the spacing between the support member 140 and the central section 110 is arranged so that the feet at the “shallow end” of the paint roller tray rest in contact with the surface 122 on the central section 110. (It may be desirable to use a special paint roller tray provided with a clip which hooks over the support member 140 on the wall side thereof, thus preventing any movement of the paint roller tray relative to the stabilizer as the paint roller is rolled within the tray.) Because the side sections 112, 114 extend horizontally from the wall 106, the paint roller tray rests on the support member 140 and central section 110 in essentially the same horizontal orientation which it occupies when placed on a flat horizontal floor, and there is no tendency for paint poured into the tray to flow over the edges of the tray. Use of a paint roller tray in this manner is not possible with a conventional ladder stabilizer, in which the side sections extend perpendicular to the ladder, since the resultant steep slope of (typically) about 17 degrees to the horizontal would cause paint to flow out of the deep end of the tray. The support member 140 can of course be used in other ways; for example, a paint pot can be suspended from the support member by means of a conventional S-shaped hook, and the resultant position of the paint pot may be more convenient for a user than hanging the paint pot from the central section 110, as is the practice with prior art ladder stabilizers.

As already indicated, FIGS. 1 and 2 are not strictly to scale, and the dimensions of the ladder stabilizer can vary substantially. Typically, the length of the side sections will be in the range of about 12 to 24 inches (about 304 to 608 mm) to provide a convenient spacing of the ladder from the wall. The width of the central section of the stabilizer can vary widely depending upon the type of building with which the stabilizer is intended to be used. Typically, the central section should be wide enough to enable the stabilizer to straddle a 3 foot (914 mm) window and its associated shutters, so that a central section having a length in the range of about 55 to 70 inches (1.40 to 1.78 m) is convenient. An excessively long central section should of course be avoided since it increases the weight of the stabilizer and the difficulty of maneuvering a ladder with the stabilizer attached. Although the stabilizer could be constructed of a rigid polymer, for example poly(vinyl chloride), ins general it is preferred that it be constructed of metal, and as already noted aluminum alloy is preferred for its combination of strength and light weight.

It will be apparent to those skilled in the art that numerous changes and modifications can be made in the specific embodiments of the present invention described above without departing from the scope of the invention. For example, the side sections need not extend at right angles to the central section as in the stabilizer shown in FIGS. 1 and 2, but could splay outwardly away from each other, thus increasing the distance between the points at which the side sections contact the wall. The feet on the side sections shown in the Figures could be replaced with larger weight-distributing discs, which could be pivotally mounted on the side sections to reduce the load per unit area placed on the wall. The side sections could be integral with the central section, i.e., the side sections and the central section could be formed by bending and twisting a single piece of tubing. Alternatively, the central section could be made telescopic, with two end portions able to slide into and out of a central portion provided with locking means to enable the end portions to be locked in position. The form of the support member could vary widely. For example, there could be a plurality of support members, conveniently in the form of a series of bars extending parallel to each other, to accommodate varying sizes of paint tray and other tools. Alternatively, a mesh could extend between two support members, or between a support member and the central section, to accommodate tools. Accordingly, the whole of the foregoing description is to be construed in an illustrative and not in a limitative sense.

1. A ladder stabilizer comprising a central section and two side sections extending in substantially the same direction from opposed ends of the central section, such that when the stabilizer is placed with the ends of the side sections remote from the central section in contact with a vertical wall of a building and the side sections and the central section lying substantially in a horizontal plane, the central section provides a substantially planar surface facing away from the vertical wall and lying at an angle of from about 12 to about 23 degrees to the vertical, the ladder stabilizer further comprising at least two clamping means arranged to clamp the central section to a rung of a ladder with said substantially planar surface in contact with the side rails of the ladder.

2. A ladder stabilizer according to claim 1 wherein, under the specified conditions, the planar surface lies at an angle of from about 15 to about 20 degrees to the vertical.

3. A ladder stabilizer according to claim 2 wherein, under the specified conditions, the planar surface lies at an angle of from about 16 to about 19 degrees to the vertical.

4. A ladder stabilizer according to claim 3 wherein, under the specified conditions, the planar surface lies at an angle of substantially 17.5 degrees to the vertical.

5. A ladder stabilizer according to claim 1 wherein the central section provides a second substantially planar surface extending substantially parallel to said substantially planar surface but on the opposed side of the central section.

6. A ladder stabilizer according to claim 1 further comprising at least one support member extending between the two side sections and spaced from the central section.

7. A ladder stabilizer according to claim 6 wherein the support member has a substantially V-shaped cross-section.

8. A ladder stabilizer according to claim 1 wherein the ends of the side sections remote from the central section are provided with deformable feet.

9. A ladder stabilizer according to claim 1 wherein the side sections and the central section formed from hollow metal tubing.

10. A ladder stabilizer according to claim 1 wherein notches are formed in the ends of the side sections adjacent the central section, and the central section is received into the notches in the side sections.

11. A ladder having a ladder stabilizer according to claim 1 secured thereto.

12. A ladder according to claim 11 having two side rails and a plurality of rungs extending between the side rails, and wherein the side rails rest in contact with said planar surface of said stabilizer, with the clamping means each extending around a rung of the ladder and around the central section of the stabilizer, with the side sections lying outside the side rails of the ladder.

13. (canceled)

14. A ladder having two side rails and a plurality of rungs extending between the side rails, in combination with a ladder stabilizer, the ladder stabilizer comprising a central section having a length of at least about 55 inches, and two side sections extending in substantially the same direction from opposed ends of the central section, such that when the stabilizer is placed with the free ends of the side sections remote from the central section in contact with a vertical wall of a building and the side sections and the central section lying substantially in a horizontal plane, the central section provides a substantially planar surface facing away from the vertical wall and lying at an angle of from about 12 to about 23 degrees to the vertical, the ladder stabilizer further comprising two clamping means extending around a single rung of the ladder and the central section of the stabilizer, such that the side sections lie a substantial distance outside the side rails of the ladder.
